(19) United States
(12) Patent Application Publication
(10) Pub. No.: US 2008/0176563 A1
(43) Pub. Date: Jul. 24, 2008

(54) SERVICE REGISTERING APPARATUS AND METHOD USING CELL RESELECTION PROCEDURE IN PORTABLE TERMINAL

(75) Inventors: Sang-Hyun LEE, Seoul (KR); Yoon-Suk Choi, Seo-gu (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/017,797

(22) Filed: Jan. 22, 2008

(30) Foreign Application Priority Data
Jan. 22, 2007 (KR) 2007-0006521

(51) Int. Cl. H04Q 7/20

(52) U.S. Cl. 455/435.2

(57) ABSTRACT

An apparatus and method for performing a service registration through a cell reselection procedure in case of a service registration failure in a portable terminal are provided. The apparatus includes a service registration manager for acquiring cell reselection parameters of a cell to be reselected and a serving cell, and applying a cell reselection offset to the acquired cell reselection parameters of the serving cell to re-execute a cell reselection procedure; and a controller for directing the serving registration manager to change the cell reselection parameters of the serving cell to a cell reselectable condition to perform the cell reselection procedure when the service registration of the portable terminal fails.

### PRIORITY

This application claims priority under 35 U.S.C. §119(a) to an application filed in the Korean Intellectual Property Office on Jan. 22, 2007 and assigned Serial No. 2007-6521, the contents of which are herein incorporated by reference.

### BACKGROUND OF THE INVENTION

1. Field of the Invention

The present invention relates generally to a service registration of a portable terminal, and in particular, to a service registering apparatus and method using a sell reselection procedure when the service registration fails in a portable terminal.

2. Description of the Related Art

In general, when a portable terminal is turned on, it searches for and selects a cell of Public Land Mobile Network (PLMN), accesses to the selected communication network, and tunes a channel.

When moving from one cell to another cell in a power-on mode, the portable terminal performs the cell reselection procedure by searching for a new adjacent cell providing a better signal quality than the serving cell.

The cell reselection procedure of the portable terminal selects a cell of better condition than the serving cell based on the propagation measurement in the idle mode and the cell reselection criteria. The portable terminal reselects a neighbor cell that meets the cell reselection criteria, among suitable cells.

FIG. 1 illustrates the cell reselection procedure in a general mobile communication system.

For example, a mobile communication system of Global System for Mobile communication (GSM)/General Packet Radio Service (GPRS) in FIG. 1 includes a plurality of cells 110, 120 and 130 which define radio coverage established by stationary site Base Stations (BSs) 112, 122, and 132 in their respective cells.

The cell 110 of FIG. 1 is the radio coverage area established by the BS 112 therein. Likewise, the other cells 120 and 130 are the radio coverage areas established by the BSs 122 and 132 respectively.

Meanwhile, when the portable terminal 100 is positioned in the overlapping coverage areas of the plurality of cells, it continuously monitors signal characteristics from the BSs of the cells 110, 120 and 130 and selects a corresponding cell through a relevant BS based on selection criteria.

For instance, when the cell 110 is selected as the optimum coverage area based on the signal characteristics from the cell 110 in terms of the cell reselection criteria, the cell 110 is regarded as the serving cell or the cell where the portable terminal 100 transceives packet data.

If the portable terminal 100 confirms the cell 130 as the optimum cell based on the signal characteristics of the cell 130, the cell 130 is reselected as the serving cell.

The above procedure is now described in more detail below.

With respect to the cells, the portable terminal 100 calculates a path loss criterion parameter value C1, a reselection criterion parameter value C2, a signal strength threshold criterion parameter value C4, a signal level threshold criterion parameter value C31, and a cell ranking criterion parameter value C32.

Provided that the order of cell-receive strengths, from highest to lowest, according to the calculations is 130, 120, and 110, the portable terminal 100 reselects from the current serving cell 110 to the cell 130.

The portable terminal 100, which camps on a serving cell in the mobile communication system, reselects a cell based on the cell reselection criteria. The cell reselection criteria for the portable terminal to attempt the cell reselection are as follows. The first cell reselection criterion is a case where the portable terminal does not receive service in the current serving cell, and the second reselection criterion is a case where a cell that provides better service than the current serving cell is discovered.

The out-of-service in the serving cell is defined in 3GPP 05.08 and 03.22 as below. The service is unavailable in the service cell when a random access fails, when a downlink signaling fails, and when a message including a system information change mark is not decoded within a certain time.

However, in the general mobile communication system, the cell reselection is performed only when a problem occurs at an Access Stratum (AS). In other words, a problem occurring at an upper layer called Non Access Stratum (NAS) is not reflected on the cell reselection procedure.

Therefore, there is a need for an apparatus and method for performing the cell reselection even when a problem occurs at the NAS in the mobile communication system.

### SUMMARY OF THE INVENTION

An aspect of the present invention is to substantially solve at least the above problems and/or disadvantages and to provide at least the advantages below. Accordingly, an aspect of the present invention is to provide an apparatus and method for keeping a continuous service when an error occurs at NAS in a portable terminal.

Another aspect of the present invention is to provide an apparatus and method for preventing a frequent cell reselection in the cell reselection procedure in a portable terminal.

A further aspect of the present invention is to provide an apparatus and method for reducing a battery consumption caused by a cell reselection in a portable terminal.

The above aspects are achieved by providing a portable terminal for performing a service registration through an abnormal cell reselection, which includes a service registration manager for acquiring cell reselection parameters of a cell to be reselected and a serving cell and applying a cell reselection offset to the acquired cell reselection parameters of the serving cell to re-execute a cell reselection procedure; and a controller for directing the serving registration manager to change the cell reselection parameters of the serving cell to a cell reselectable condition to perform the cell reselection procedure when the service registration of the portable terminal fails.

According to one aspect of the present invention, a method for performing a service registration through an abnormal cell reselection in a portable terminal, includes when a service registration is failed, acquiring cell reselection parameters of a serving cell of the portable terminal and a cell to be reselected; applying a cell reselection offset to the cell reselection parameters of the serving cell to enable the cell reselection; and when the cell reselection parameters of the serving cell are less than the cell reselection parameters of the cell to be reselected, performing the cell reselection and re-executing the service registration.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a cell reselection procedure in a general mobile communication system;

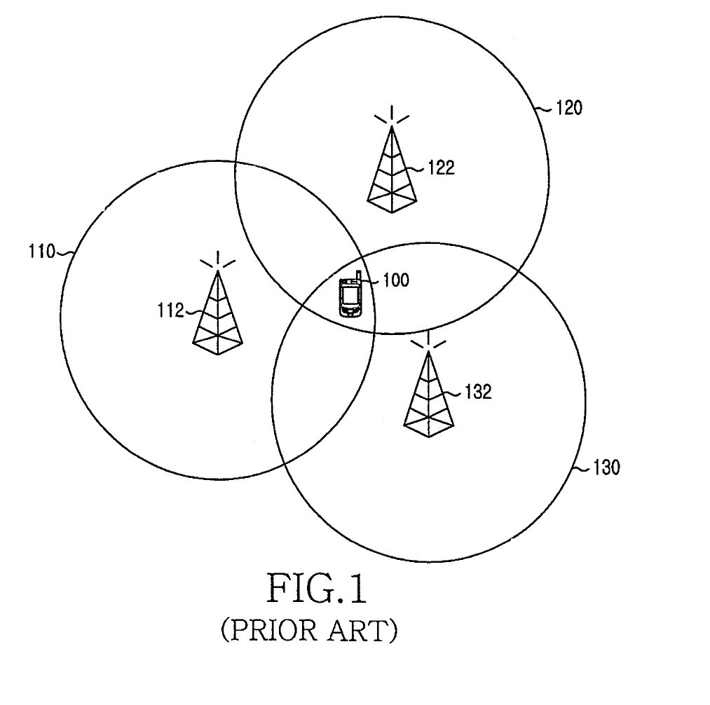

FIG. 2 is a block diagram of a portable terminal for re-performing a service registration according to the present invention; and

FIG. 3 is a flowchart of the service registration re-execution in the portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for forcibly performing a cell reselection and re-executing a service registration in the reselected cell when a portable terminal fails the service registration.

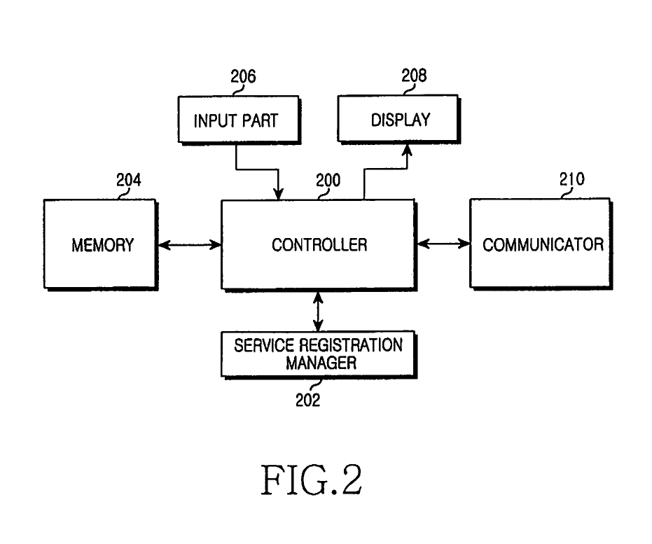

FIG. 2 is a block diagram of a portable terminal for re-performing a service registration according to the present invention. The portable terminal can include any mobile communication terminal such as a cellular phone, a Personal Communication System (PCS) phone, a Personal Digital Assistant (PDA), an International Mobile Telecommunication (IMT)-2000 phone, and 4^{th}-generation (4G) broadband system phone. Hereafter, a typical structure of the mobile communication terminal is illustrated.

The portable terminal of FIG. 2 includes a controller 200, a service registration manager 202, a memory 204, an input part 206, a display 208, and a communicator 210.

The controller 200 controls an overall operation of the portable terminal. For example, the controller 200 processes and controls voice calls and data communications. In addition to the typical functions, when confirming a failure of a registration procedure such as Location Area Update (LAU) and GPRS attach procedure, the controller 200 re-executes the registration procedure through the cell reselection.

In more detail, when confirming the failure of the registration procedure, the controller 200 controls the service registration manager 202 to examine cell reselection parameters of a cell to be reselected and the serving cell.

After the portable terminal determines whether to re-perform the service registration, the controller 200 controls the service registration manager 202 to apply a preset offset to the cell reselection parameters of the confirmed serving cell to re-execute the cell reselection.

The service registration manager 202 examines the cell reselection parameters of the serving cell and the cell to be reselected to re-execute the cell reselection according to the directions of the controller 200.

Also, the serving registration manager 202 satisfies a cell reselection condition by applying an offset to the cell reselection parameters of the serving cell according to the directions of the controller 200.

Specifically, the service registration manager 202 examines a path loss criterion parameter value C1, a reselection criterion parameter value C2, and a cell ranking criterion parameter value C32 with respect to the serving cell and the cell to be reselected. When confirming the re-execution of the service registration of the portable terminal from the controller 200, the service registration manager 202 satisfies the cell reselection condition by applying a preset offset to the C2 value and the C32 value of the serving cell.

In the meantime, when confirming no re-execution of the service registration of the portable terminal from the controller 200, the service registration manager 202 satisfies the cell reselection condition by setting the C1 value of the serving cell to “0”.

The memory 204 includes a Read Only Memory (ROM), a Random Access Memory (RAM), and a flash ROM. The ROM contains microcodes and reference data of programs for processing and controlling the controller 200 and the service registration manager 202.

The RAM, which is a working memory of the controller 200, stores temporary data generated during program executions. The flash ROM stores updatable data such as a phone book, sent messages, and received messages.

According to the present invention, the memory 204 contains various parameter values required to determine a cell reselection. Some of the parameter values are acquired from the received system information, and some are measured at the portable terminal.

The input part 206 includes a plurality of function keys such as number buttons ‘0’ to ‘9’, a menu button, a CANCEL (DELETE) button, an OK button, a TALK button, an END button, an Internet access button, navigation buttons (or direction keys), and character keys. The input part 206 provides key input data, corresponding to keys pressed by a user, to the controller 200.

The display 208 displays state information generated during operation of the portable terminal, a limited number of characters, videos, and still images. The display 208 can include a Liquid Crystal Display (LCD).

The communicator 210 transmits, receives, and processes radio signals of data input and output over an antenna (not shown). For example, in the transmission, the communicator 210 channel-codes, spreads, Radio Frequency (RF)-processes, and transmits data to be sent. During reception, the communicator 210 converts a received RF signal to a baseband signal, despreads and channel-decodes the baseband signal, and thus restores the data.

While the controller 200 can function as the service registration manager 202 in the portable terminal, the controller 200 and the service registration manager 202 are separately provided to distinguish their functions. In the actual implementation, the controller 200 can function as the service registration manager 202.

The apparatus for re-executing the service registration through the cell selection in case of the service registration failure has been illustrated. A method for re-executing the service registration using the apparatus is described below.

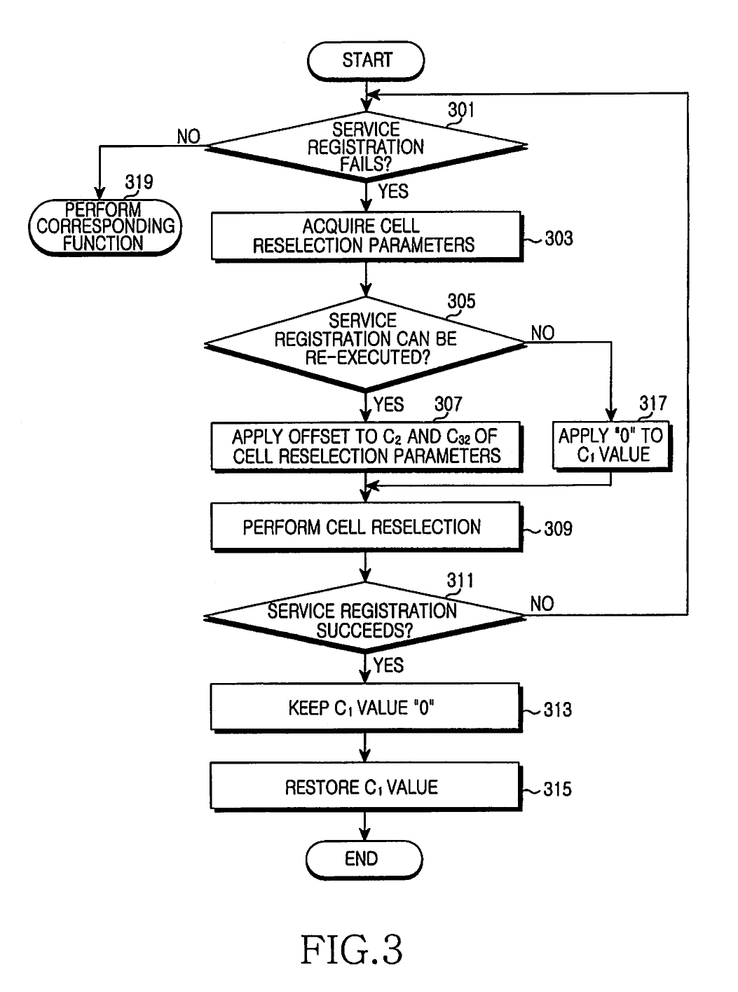

FIG. 3 is a flowchart of the service registration re-execution in the portable terminal according to the present invention.

Referring to FIG. 3, the controller 200 of the portable terminal checks whether the service registration fails or not in step 301. Herein, the service registration is the failed service registration procedure because of the error at the NAS. The service registration can include a registration procedure such as a Location Area Update (LAU) procedure and a GPRS attach procedure.

When the controller 200 does not confirm a service registration failure, the controller 200 performs a corresponding function (e.g., a standby mode) in step 319.

In step 303, the controller 200 directs the service registration manager 202 to confirm the cell reselection parameters of the service cell and the cell to be reselected. According to the directions of the controller 200, the service registration manager 202 examines the path loss criterion parameter value Cl, the reselection criterion parameter value C2, and the cell ranking criterion parameter value C32 of the pre-measured serving cell and the cell to be reselected as defined in the standard.

Next, the controller 200 determines whether the portable terminal can re-execute the service registration, in step 305. When the portable terminal fails the registration procedure, such as the LAU procedure and the GPRS attach procedure; i.e., when the portable terminal re-executes the registration procedure for below a re-execution threshold, the controller 200 determines that the service registration is re-executable.

If the portable terminal performs the service re-execution by the re-execution threshold or the access control is barred in a Mobility Management (MM) connection, the controller 200 does not re-execute of the service registration; i.e., when the portable terminal cannot examine parameters available in a Random Access CHannel (RACH), re-execution of the service registration does not occur.

If the portable terminal cannot re-execute the service registration in step 305, the controller 200 directs the service registration manager 202 to alter the path loss criterion parameter value C1, among the calculated cell reselection parameters of the serving cell, to “0”, in step 317 and then performs the cell reselection in step 309.

After the path loss criterion parameter C1 value is altered to “0” by the service registration manager 202, when the cell reselection procedure or the cell selection procedure fails, the controller 200 performs an operation defined in the existing specification (e.g., a C1 value recovery).

By contrast, if the controller 200 determines that the portable terminal can re-execute the service registration in step 305, the controller 200 directs the service registration manager 202 to apply a preset offset to the reselection criterion parameter C2 value and the cell ranking criterion parameter C32 value of the cell reselection parameters of the serving cell in step 307.

For example, according to the directions of the controller 200, the service registration manager 202 can apply the preset offset to the measured C2 and C32 values as follows:

C2=C2−OFFSET

C32=C32−OFFSET

Next, the controller 200 executes the cell reselection procedure in step 309 and performs the service registration in the reselected cell.

In step 311, the controller 200 determines whether the service registration is successful or not. If the service registration fails, the controller 200 repeats the step 301.

If the service registration is successful, the controller 200 directs the service registration manager 202 to alter the C1 value of the cell reselection parameters of the serving cell to “0” in step 313.

The path loss criterion parameter value C1 is altered to “0” in order to prevent a ping-pong phenomenon, which may occur after the cell reselection procedure.

When confirming the MM connection, the controller 200 recovers the original C1 value in step 315.

Next, the controller 200 terminates this process.

As set forth above, the present invention provides the apparatus and method for maintaining the continuous service of the portable terminal when an error occurs at the NAS. Note that the present invention is applicable to a case where cell access is blocked and a case where an access class cannot request resources as well as the case where the error occurs at the NAS.

In a case of a service registration failure, the portable terminal forcibly performs a cell reselection by altering the cell reselection parameters and re-executes the service registration in the reselected cell.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable terminal for performing a service registration through an abnormal cell reselection, comprising:
a service registration manager for acquiring cell reselection parameters of a cell to be reselected and a serving cell, and applying a cell reselection offset to the acquired cell reselection parameters of the serving cell to re-execute a cell reselection procedure; and
a controller for, when the service registration of the portable terminal fails, directing the service registration manager to change the cell reselection parameters of the serving cell to a cell reselectable condition to perform the cell reselection procedure.

2. The portable terminal of claim 1, wherein the service registration manager acquires the cell reselection parameter including at least one of a path loss criterion parameter value C1, a reselection criterion parameter value C2, a signal strength threshold criterion parameter value C4, a signal level threshold criterion parameter value C31, and a cell ranking criterion parameter value C32 with respect to the serving cell and the cell to be reselected.

3. The portable terminal of claim 1, wherein, if the portable terminal, which fails the service registration, is able to re-execute the service registration, the controller directs the service registration manager to apply a preset offset to the reselection criterion parameter value C2 and the cell ranking criterion parameter value C32 of the cell reselection parameters of the serving cell.

4. The portable terminal of claim 3, wherein, if the portable terminal, which fails the service registration, is not able to re-execute the service registration, the controller directs the service registration manager to apply a preset offset to the path loss criterion parameter C1 value of the cell reselection parameters of the serving cell.

5. The portable terminal of claim 3, wherein, upon confirming a completion of the cell reselection, the controller directs the service registration manager to change the path loss criterion parameter C1 value of the cell reselection parameters of the serving cell.

6. The portable terminal of claim 5, wherein, when the service registration fails, a service registration procedure that fails because of an error at a Non Access Stratum (NAS) includes at least one of a Location Area Update (LAU) procedure and a General Packet Radio Service (GPRS) attach procedure.

7. The portable terminal of claim 1, wherein the abnormal cell reselection is performed in at least one of a case where an error occurs at a NAS, a case where a cell access is banned, and a case where an access class does not request resource.

8. A method for performing a service registration through an abnormal cell reselection in a portable terminal, the method comprising:
when a service registration fails, acquiring cell reselection parameters of a serving cell of the portable terminal and a cell to be reselected;
applying a cell reselection offset to the cell reselection parameters of the serving cell to enable the cell reselection; and
when the cell reselection parameters of the serving cell are less than the cell reselection parameters of the cell to be reselected, performing the cell reselection and re-executing the service registration.

9. The method of claim 8, further comprising:
upon confirming a completion of the cell reselection, applying a preset offset to a path loss criterion parameter value C1 of the cell reselection parameters of the serving cell.

10. The method of claim 8, wherein applying the cell reselection offset comprises:
when the portable terminal is able to re-execute the service registration in the serving cell, applying a preset offset to a reselection criterion parameter value C2 and a cell ranking criterion parameter value C32 of the acquired cell reselection parameters of the serving cell; and
when the portable terminal is not able to re-execute the service registration, applying a preset offset to a path loss criterion parameter value C1 of the acquired cell reselection parameters of the serving cell.

11. The method of claim 10, wherein the cell reselection parameter includes at least one of the path loss criterion parameter value C1, the reselection criterion parameter value C2, a signal strength threshold criterion parameter value C4, a signal level threshold criterion parameter value C31, and the cell ranking criterion parameter value C32 with respect to the serving cell and the cell to be reselected.

12. The method of claim 8, wherein, when the service registration fails, a service registration procedure that fails because of an error at a Non Access Stratum (NAS) includes at least one of a Location Area Update (LAU) procedure and a General Packet Radio Service (GPRS) attach procedure.

13. The method of claim 8, wherein the abnormal cell reselection is performed in at least one of a case where an error occurs at a NAS, a case where a cell access is banned, and a case where an access class does not request resources.

14. An apparatus for performing a service registration in a portable terminal, the method comprising:
means for acquiring cell reselection parameters of a serving cell of the portable terminal and a cell to be reselected;
means for applying a cell reselection offset to the cell reselection parameters of the serving cell to enable the cell reselection; and
means for, when the cell reselection parameters of the serving cell are less than the cell reselection parameters of the cell to be reselected, performing the cell reselection and re-executing the service registration.

15. A computer-readable recording medium having recorded thereon a program for performing a service registration in a portable terminal, comprising:
a first code segment, for acquiring cell reselection parameters of a serving cell of the portable terminal and a cell to be reselected;
a second code segment, for applying a cell reselection offset to the cell reselection parameters of the serving cell to enable the cell reselection; and
a third code segment, for, when the cell reselection parameters of the serving cell are less than the cell reselection parameters of the cell to be reselected, performing the cell reselection and re-executing the service registration.
